(19) United States
(12) Patent Application Publication
(10) Pub. No.: US 2021/0129480 A1
(43) Pub. Date: May 6, 2021

(54) MICROSTRUCTURED ELASTOMERIC FILM AND METHOD FOR MAKING THEREOF

(71) Applicant: 3M INNOVATIVE PROPERTIES COMPANY, St. Paul, MN (US)

(72) Inventors: John D. Le, Woodbury, MN (US); Michael Benton Free, Stillwater, MN (US); Margot A. Branigan, Roseville, MN (US); Susan L. Kent, Shorewood, MN (US); Michael L. Steiner, New Richmond, WI (US); Robert M. Jennings, Shoreview, MN (US); Richard J. Ferguson, Eau Claire, MN (US)

(21) Appl. No.: 16/486,976

(22) PCT Filed: Feb. 16, 2018
(86) PCT No.: PCT/IB2018/050968

§ 371 Date: Aug. 19, 2019

Related U.S. Application Data
(60) Provisional application No. 62/460,917, filed on Feb. 20, 2017.

(51) Int. Cl. B32B 3/30; B32B 27/32; B32B 37/15; B32B 37/24; B32B 7/06; B32B 7/12; B32B 27/08; B32B 38/10

(52) U.S. Cl. CPC B32B 3/30; B32B 27/32; B32B 37/153; B32B 37/24; B32B 7/06; B32B 7/12; G06F 3/0447; B32B 38/10; B32B 2255/10; B32B 2255/26; B32B 2037/243; B32B 2307/748; B32B 2457/208; B32B 27/08

(57) ABSTRACT

A lamination transfer article includes an elastomeric layer with a first major surface including an array of discrete microstructures separated by land areas, wherein the microstructures in the array have a top surface; a first tie layer overlying at least some of the top surfaces of the microstructures of the elastomeric layer, wherein the land areas on the first major surface are uncovered by the first tie layer; and a second layer on a second major surface of the elastomeric layer, wherein the second layer is chosen from a second tie layer and a polymeric carrier film.

### BACKGROUND

Force-sensing capacitor elements can be used in touch displays, keyboards, and touch pads in electronic devices, as well as in force, touch and pressure sensors. The force-sensing capacitor elements can be integrated, for example, at the periphery of or beneath a display, to sense or measure force applied to the display. The force-sensing capacitor elements can also be integrated within, for example, a touch pad, keyboard, or digitizer (e.g., stylus input device).

When used in a display of an electronic device, a force-sensing capacitor element should have good linearity of response, good speed of response and speed of recovery, preserve the mechanical robustness of the device, preserve the hermicity of the device where desired, and have a thin construction. The response of the force-sensing capacitor elements should be sensitive and repeatable. The force-sensing capacitor element should have a long lifetime, allow determination of position or positions of force application, and reject noise.

Arrays of compressible structures in a force-sensing capacitor element can be used as “springs” during detection of the magnitude and/or direction of force or pressure applied to the display or electronic device. When a compressible elastomeric film is utilized as, for example, a capacitive force-sensing sensor material component in an electronic device, the film needs to respond to wide range of stimuli, including user-specific stimuli and device durability stimuli. For example, for touch sensing applications, the film construction needs to detect very small touch forces, but also should be sufficiently resilient to resist high impact forces and reduce damage when the electronic device is dropped by a user. The elastomeric film should maintain a consistent baseline and response signal throughout repeated use and environmental change, and for films used in consumer products should be low in manufacturing cost for both sensor materials and integration. The structural design of the elastomeric film allows one to optimize different material and component attributes, e.g., bonding area, compliant material volume, air volume, and the like.

Arrays of compressible structures have been made by microreplication, which refers generally to a fabrication technique wherein precisely shaped topographical structures are prepared by casting or molding a polymer (or polymer precursor that is later cured to form a polymer) film in a production tool, e.g. a mold, a film with cavities or an embossing tool.

Arrays of compressible structures for force-sensing elements have also been made using an extrusion process, as well as by laser ablation and mechanical die cutting. Casting or molding on a microstructured tool makes possible the creation of more precise and accurate arrays of small compressible structures such filaments or posts with dimensions of less than 0.5 mm.

### SUMMARY

In general, the present disclosure is directed to a method of making and delivering a microstructured elastomeric film that could be utilized as, for example, a capacitive force-sensing sensor material component in an electronic device such as a force, touch, or pressure sensor. The microstructured elastomeric film is made using a microstructured film tool that is a negative of the desired elastomer surface structure. An elastomeric layer is applied and cured on a surface of a single microstructured film tool or between two microstructured film tool surfaces.

The microstructured film tool can be used as a carrier for the microstructured elastomeric film, and maintains the alignment and structural integrity of the microstructured elastomeric film during further processing steps as additional intermediate layer(s) are applied. For example, adhesive layers, tie layers, buffer layers, reinforcing layers, electrically conductive layers, or different material layers can be applied to the microstructured elastomeric film to adhere or bond the film to another component, or to provide additional functionality. The resulting compressible structure has an optimized material performance matrix including compliance, compression set resistance, fatigue resistance, creep resistance, dynamic compression and recovery response, surface bonding area for structural strength, impact resistance, and the like for a designed set of stimuli.

The microstructured film tool carrier also supports the microstructured elastomeric film during delivery and up until the microstructured elastomeric film is needed in a subsequent manufacturing step. When the microstructured elastomeric film is removed from the microstructured film tool, the microstructured elastomeric film may be attached to another component or integrated into a display, touch pad, keyboard, or digitizer (e.g., stylus input device).

In one aspect, the present disclosure is directed to a lamination transfer article including an elastomeric layer with a first major surface with an array of discrete microstructures separated by land areas, wherein the microstructures in the array have a top surface; a first tie layer overlying at least some of the top surfaces of the microstructures of the elastomeric layer, wherein the land areas on the first major surface are uncovered by the first tie layer; and a second layer on a second major surface of the elastomeric layer, wherein the second layer is chosen from a second tie layer and a polymeric carrier film.

In another aspect, the present disclosure is directed to a method for making an elastomeric article, including coating a first adhesive layer on a portion of a mictrostructured major surface of a tool, wherein the major surface of the tool includes an array of discrete microstructures and cavities between the microstructures, wherein the first adhesive layer resides in the cavities and the tops of the microstructures protrude above the first adhesive layer, and wherein the adhesive layer has a first major surface contacting the microstructured major surface of the tool; casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool; laminating a release liner onto the second major surface of the layer of the elastomeric precursor material opposite the first major surface thereof, wherein the release liner includes a second adhesive layer on the second major surface of the layer of the elastomeric precursor material and a polymeric film on the second adhesive layer; and curing the elastomeric precursor material to form an elastomeric layer.

In another aspect, the present disclosure is directed to a method for making an elastomeric article including extruding a polymeric material into a nip between a microstructured roller and a backup roller to form a tool, wherein the tool includes a first microstructured major surface and a second major surface opposite the first microstructured major surface, and wherein the microstructured major surface of the tool includes an array of discrete microstructures and cavities between the microstructures; coating a first adhesive layer on the mictrostructured major surface of the tool, wherein the first adhesive layer resides in the cavities and the tops of the microstructures protrude above the first adhesive layer, and wherein the adhesive layer has a first major surface contacting the microstructured major surface of the tool; casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool; laminating a carrier film onto the second major surface of the layer of the elastomeric precursor material opposite the first major surface thereof, wherein the carrier film includes a second adhesive layer on the second major surface of the layer of the elastomeric precursor material and a polymeric laminate film on the second adhesive layer; and curing the elastomeric precursor material to form an elastomeric layer.

In another aspect, the present disclosure is directed to a compressive sensor, including a first elastomeric layer with a first major surface having a first array of continuous lines of microstructures separated by land areas, wherein the lines of microstructures in the first array extend along a first direction in a first plane, wherein the microstructures in the first array project in a first direction normal to and above the first plane, and wherein the microstructures in the first array include a distal end with a top surface; a first tie layer overlying at least some of the top surfaces of the microstructures of the first elastomeric layer, wherein the land areas on the first major surface are uncovered by the first tie layer; and a second tie layer on a second major surface of the first elastomeric layer; and a second elastomeric layer, including a first major surface with a second array of continuous lines of microstructures separated by land areas, wherein the lines of microstructures in the second array extend along a second direction in a second plane, and the second direction in the second plane is different from the first direction in the first plane, and wherein the microstructures in the array project in a second direction normal to and above the second plane, wherein the second direction normal to and above the second plane is opposite the first direction normal to and above the first plane, and wherein the microstructures in the first array comprise a distal end with a top surface; a first tie layer overlying at least some of the top surfaces of the microstructures of the second elastomeric layer, wherein the land areas on the first major surface are uncovered by the first tie layer; and a second tie layer on a second major surface of the second elastomeric layer, wherein the second tie layer on the second major surface of the second elastomeric layer contacts the second tie layer on the second major surface of the first elastomeric layer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a cross-sectional view of an embodiment of an elastomeric construction including a release liner and a polymeric film tool.

FIG. 2 is a cross-sectional view of an embodiment of an elastomeric construction including a release liner and a polymeric film tool.

FIG. 3 is a cross-sectional view of an embodiment of a polymeric support layer of FIG. 2.

FIG. 4 is a cross-sectional view of an embodiment of a structured elastomeric article.

FIG. 5 is a cross-sectional view of an embodiment of a structured elastomeric article.

FIG. 6A is a cross-sectional view of an embodiment of a structured elastomeric article with outer surfaces contacting electrodes of an electrically conductive silver ink.

FIG. 6B is an overhead view of the structured elastomeric article of FIG. 6A.

FIG. 7A is a schematic perspective view of an extrusion replication process to produce a microstructured polymer material.

FIG. 7B is a schematic perspective view of a solvent coating step in which a tie layer is applied on the microstructured polymer material and the resulting construction is cured to form a microstructured film tool with a tie layer.

FIG. 7C is a schematic perspective view of a solvent coating step in which an elastomeric layer is formed on microstructured film tool of FIG. 7B.

FIG. 7D is a schematic perspective view of a lamination step in which a release liner is applied on the elastomeric construction of FIG. 7C.

FIG. 7E is a schematic cross-sectional view of an elastomeric layer formed after the microstructured film tool and the release liner are removed following the lamination step of FIG. 7D.

FIG. 8 is a plot of the capacitance vs. applied force for the elastomeric constructions of Examples 2A-2B.

FIG. 9 is a plot of the capacitance vs. applied force for the elastomeric construction of Example 4.

FIG. 10 is a plot of the capacitance vs. applied force for the elastomeric construction of Example 5.

FIG. 11 is a plot of the capacitance vs. applied force for the elastomeric construction of Example 6.

FIG. 12 is a plot of the capacitance vs. applied force for the elastomeric construction of Example 7.

Like symbols in the figured are directed to like elements.

### DETAILED DESCRIPTION

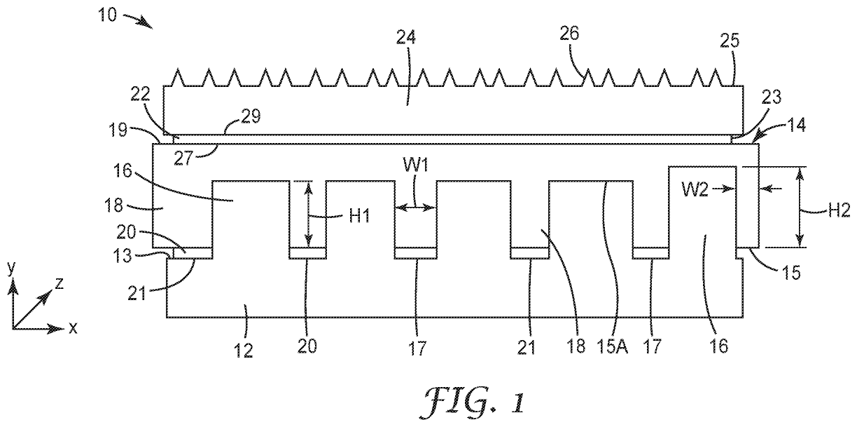

FIG. 1 is a cross-sectional view of a laminate construction 10 including a microstructured film tool 12 (hereafter referred to as the film tool 12) and a microstructured elastomeric film 14 (hereafter referred to as the elastomeric film 14) carried on the film tool 12. The film tool 12 includes an array of a plurality of precisely shaped structures 16 in a major surface 13 thereof, which may protrude from a surface 13, form depressions in the surface 13, or a combination thereof. In various embodiments, the film tool 12 provides a production template to form an array of a plurality of precisely shaped structures 18 in a first major surface 15 of the elastomeric film 14, with the array of structures 18 being the inverse of the array of structures 16.

The film tool 12 is formed by “micro-replication,” which refers to a fabrication technique in which precisely shaped topographical structures are prepared by casting or molding a polymer (or polymer precursor that is later cured to form a polymer) in a production tool. “Precisely shaped” refers to a topographical structure having a molded shape that is the inverse shape of a corresponding mold cavity, said shape being retained after the topographical feature is removed from the mold.

In various embodiments, the production tool may be a mold, a film or an embossing tool having a plurality of micron sized to millimeter sized topographical structures. In some embodiments, embossing tool may be a removable textured liner or textured release liner that has the inverse pattern of structures as that desired for the final structures in the film tool 12. When the polymer is removed from the production tool, a series of topographical structures are present in the surface of the polymer. The topographical structures of the polymer surface have the inverse shape of the features of the original production tool.

In some embodiments, the film tool 12 is a textured film, liner or release liner made of a polymer, e.g. a thermoplastic polymer or a cured thermoset resin. Suitable polymers for the film tool 12 include, but are not limited to polyurethanes; polyalkylenes such as polyethylene and polypropylene; polybutadiene, polyisoprene; polyalkylene oxides such as polyethylene oxide; polyesters such as PET and PBT; polyamides; polyimides, polysilicones, polycarbonates, polystyrenes, polytetrafluoroethylene, polyethylenephthalate, block copolymers of any of the proceeding polymers, and combinations thereof. Polymer blends may also be employed.

In some embodiments, the film tool 12 may be made of non-polymeric materials such as, for example, densified Kraft paper (such as those commercially available from Loparex North America, Willowbrook, Ill.), or poly-coated paper such as polyethylene coated Kraft paper. Nonwoven or woven liners may also be useful.

In some embodiments, the film tool 12 may be a release liner that can separated from the elastomeric film 14. In some embodiments, the film tool 12 may release from the elastomeric film 14 without a release coating. In other embodiments, the film tool 12 includes a release coating on the microstructured surface 13 thereof (release coating not shown in FIG. 1) to facilitate separation from the elastomeric film 14. The film tool 12 can protect the elastomeric film 14 during handling and can be removed, when desired, to transfer of the elastomeric film 14, or part thereof, to a substrate. Exemplary liners useful for the disclosed article are disclosed in PCT Pat. Appl. Publ. No. WO 2012/082536 (Baran et al.). The film tool 12 may be flexible or rigid, and is preferably flexible. In some embodiments, the film tool 12 is about 0.5 mil (0.01 mm) thick to about 20 mils (0.50 mm) thick.

In various embodiments, which are not intended to be limiting, the release coating on the surface 13 of the film tool 12 may be a fluorine-containing material, a silicone-containing material, a fluoropolymer, a silicone polymer, or a poly(meth)acrylate ester derived from a monomer comprising an alkyl (meth)acrylate having an alkyl group with 12 to 30 carbon atoms. In one embodiment, the alkyl group can be branched. Illustrative examples of useful fluoropolymers and silicone polymers can be found in U.S. Pat. No. 4,472,480 (Olson), U.S. Pat. Nos. 4,567,073 and 4,614,667 (both Larson et al.). Illustrative examples of a useful poly(meth)acrylate ester can be found in U.S. Pat. Appl. Publ. No. 2005/118352 (Suwa).

The micron to millimeter sized structures 16 in the surface 13 of the film tool 12 are separated by substantially flat land areas 17, which are devoid of structures 16. A first tie layer 20 resides in at least some of the land areas 17. The tie layer 20 includes surfaces 21 that contact the surface 13 of the film tool 12. In various embodiments, the first tie layer 20 includes any thermoplastic elastomer that adheres well to a surface 15B on the tops of the structures 16 in the elastomeric layer 14, and releases from the surface 13 of the film tool 12 when the film tool 12 is separated from the elastomeric layer 14.

After the film tool 12 is removed from the elastomeric layer 14, the first tie layer 20 may be used to bond the elastomeric layer 14 to another component such as, for example, an electrode construction in an electronic device. Suitable materials for the first tie layer 20 include, but are not limited to, silicone thermoplastic elastomers. In some embodiments, which are not intended to be limiting, the first tie layer 20 may include polydiorganosiloxane polyoxamide, linear, block copolymers, i.e. silicone polyoxamide, such as those disclosed in U.S. Pat. No. 7,371,464 (Sherman, et. al.) and U.S. Pat. No. 7,501,184 (Leir, et. al.), which are incorporated herein by reference in their entirety. The molecular weight of the thermoplastic elastomers suitable for the first tie layer 20 is not particularly limited. In some example embodiments, the number average molecular weight of the thermoplastic elastomers is between about 2000 g/mol and 1200000 g/mole, between about 2000 g/mol and 750000 g/mole, between about 2000 g/mol and 500000 g/mole or even between about 2000 g/mol and 250000 g/mole.

The elastomeric layer 14 may be made of any suitable silicone polymer. In some embodiments, the silicone polymer has a glass transition temperature less than about −20° C., less than about −30° C., less than about −40° C., or even less than about −50° C. In some embodiments, the silicone polymer has a glass transition temperature of greater than −150° C. In some embodiments, the glass transition temperature of the silicone polymer is between about −150° C. and about −20° C., between about −150° C. and about −30° C., between about −150° C. and about −40° C. or even between about −150° C. and about −50° C. A glass transition temperature well below room temperature is desired, as the silicone polymer will then be in the rubbery state, as opposed to a glassy state, under normal use conditions. A silicone polymer in the rubbery state will have a lower compression modulus compared to a silicon polymer in the glass state. The lower compression modulus will lead to a lower force required to compress the elastomeric layer 14.

In some embodiments, the silicone polymer used for the elastomeric layer 14 may have a rapid, elastic recovery and little viscous dissipation or loss. The ratio of the viscous loss to elastic recovery can be related to the value of the tan delta in a conventional dynamic mechanical thermal analysis test (DMTA). In some embodiments, the tan delta of the silicone polymer of the elastomeric layer 14 may be between about 0.5 and about 0.0001, between about 0.2 and about 0.0001, between about 0.1 and about 0.0001, between about 0.05 and about 0.0001 or even between about 0.01 and about 0.0001 over a temperature range from about −30° C. to about 50° C. at a frequency of about 1 Hz.

In some embodiments, the silicone polymer of the elastomeric layer 14 is chosen from a cured, silicone elastomer, a silicone thermoplastic elastomer, and combinations thereof. The cured silicone elastomer may include polysiloxanes and polyureas, including, but not limited to polydimethylsiloxane, polymethylhydrosiloxane, polymethylphenylsiloxane, polysiloxane copolymers, and polysiloxane graft copolymers. The polysiloxanes may be cured by known mechanisms, including but not limited to, addition cure systems, e.g. platinum based cure systems; condensation cure systems, e.g. tin based cure systems, and peroxide based cure systems. A polysiloxane precursor resin, which may be at least one of the polysiloxanes discussed above, which includes a cure system may be cured to form a cured silicone elastomer. Silicone thermoplastic elastomers, include, but are not limited to, polydiorganosiloxane polyoxamide, linear, block copolymers, i.e. silicone polyoxamide, such as those disclosed in U.S. Pat. No. 7,371,464 (Sherman, et. al.) and U.S. Pat. No. 7,501,184 (Len, et. al.), as well as silicone polyureas disclosed in U.S. Pat. No. 5,214,119 (Leir, et al.), which are incorporated herein by reference in their entirety. In some embodiments, the elastomeric layer may include an optional tackifier to modify its properties.

In some embodiments, the silicone precursor resin used to form the elastomeric layer 14 may include an optional foaming agent, and when cured forms a silicone elastomer foam. In some embodiments, the foam has a porosity of from about 20 percent to about 80 percent, from about 25 percent to about 80 percent, from about 30 percent to about 80 percent, from about 20 percent to about 75 percent, from about 25 percent to about 75 percent, from about 30 percent to about 75 percent, from about 20 percent to about 70 percent, from about 25 percent to about 70 percent or even from about 30 percent to about 70 percent. Conventional foaming techniques may be employed to make the foamed elastomeric layer 14, including the use of one or more foaming agents.

The elastomeric layer 14 includes a plurality of micron to millimeter-sized structures 18 formed by micro-replication techniques such as those disclosed in U.S. Pat. Nos. 6,285,001; 6,372,323; 5,152,917; 5,435,816; 6,852,766; 7,091,255 and U.S. Patent Application Publication No. 2010/0188751, all of which are incorporated herein by reference in their entirety. The dimensions, height, width and length of the structures 18 are determined by the shape of the structures 16 in the film tool 12 used to form them. The structures 16 in the textured surface 13 of the film tool 12 create the inverse pattern of shapes of the desired plurality of structures 18 in the first major surface 15A of the elastomeric layer 14.

The shape of the plurality of precisely shaped structures 18 in the elastomeric layer 14 is not particularly limited and may include, but is not limited to; circular cylindrical; elliptical cylindrical; polygonal prisms, e.g. pentagonal prism, hexagonal prisms and octagonal prisms; pyramidal and truncated pyramidal, wherein the pyramidal shape may include between 3 to 10 sidewalls; cuboidal; e.g., square cube or rectangular cuboid; conical; truncated conical, annular, spiral and the like. Combinations of shapes may be used. The plurality of precisely shaped structures may be arranged randomly across the first major surface 15A of the elastomeric layer 14, or may be arranged in a pattern, e.g. a repeating pattern. In various embodiments, which are not intended to be limiting, the patterns include square arrays, hexagonal arrays, and combinations thereof.

The plurality of precisely shaped structures 18 on the surface 15A of the elastomeric layer 14 may also be in continuous or discontinuous lines. The lines may be straight, curved or wavy and may be parallel, randomly spaced or placed in a pattern. Combinations of different line types and patterns may be used. The cross-sectional shape (the cross-section defined by a plane perpendicular to the length) of the lines is not particularly limited and may include, but is not limited to, triangular, truncated triangular, square, rectangular, trapezoidal, hemispherical and the like. Combinations of different cross-sectional shapes may be used, and some embodiments the cross-sectional shapes are acute trapezoidal, which in the present application refers to a trapezoid with a sidewall angle of less than about 20°, or less than about 10°, or less than about 5°.

In the embodiment shown in FIG. 1, which is not intended to be limiting and is provided as an example, the plurality of precisely shaped first and second structures on the surface 15A of the elastomeric layer 14 have differing heights H1 and H2 relative to the surface 15B, which each may be about 0.5 micron to about 500 microns, about 2.5 microns to about 500 microns, about 5 microns to about 500 microns, about 25 microns to about 500 microns, about 0.5 micron to about 375 microns, about 2.5 microns to about 375 microns, about 5 microns to about 375 microns, about 25 microns to about 375 microns, 0.5 micron to about 250 microns, about 2.5 microns to about 250 microns, about 5 microns to about 250 microns, about 25 microns to about 250 microns, about 0.1 micron to about 125 microns, about 2.5 microns to about 125 microns, about 5 microns to about 125 microns, or about 25 microns and about 125 microns.

In some embodiments, the plurality of precisely shaped first and second structures on the surface 15A of the elastomeric layer 14 may have differing widths W1 and W2 of about 1 micron and about 3000 microns, about 5 microns to about 3000 microns, about 10 microns to about 3000 microns, about 50 microns to about 3000 microns, about 1 micron to about 2000 microns, about 5 microns to about 2000 microns, about 10 microns to about 2000 microns, about 50 microns to about 2000 microns, about 1 micron to about 1000 microns, about 5 microns to about 1000 microns, about 10 microns to about 1000 microns, about 50 microns to about 1000 microns, about 1 micron to about 500 micron, about 5 microns to about 500 microns, about 10 microns to about 500 microns, or about 50 microns to about 500 microns.

The lengths of the of the plurality of precisely shaped first and second structures, respectively, of the surface 15A of the elastomeric layer 14, which extend along the z-direction in FIG. 1, are not particularly limited, and may be as long as the length of the compressible multilayer article 10.

The heights H1 of the first structures may all be the same or may be different. The heights H2 of the second structures may all be the same or may be different. The widths, W1 of the first structures may all be the same or may be different. The widths W2 of the second structures may all be the same or may be different. The lengths of the first and the second structures may all be the same or may be different.

In some embodiments, the aspect ratios, H1/W1 and H2/W2, of the of the plurality of precisely shaped, first and second structures, respectively, of the elastomeric layer 14 may be about 0.05 to about 2.5, about 0.05 to about 1.5, about 0.05 to about 1, about 0.1 to about 0.5, about 0.1 to about 2.5, about 0.2 to about 1.5, about 0.1 to about 1, about 0.1 to about 0.5, about 0.15 to about 2.5, about 0.15 to about 1.5, about 0.15 to about 1, about 0.15 to about 0.5, about 0.2 to about 2.5, about 0.2 to about 1.5, about 0.2 to about 1, or about 0.2 to about 0.5.

Referring again to FIG. 1, a first major surface 27 of a second tie layer 22 is on a second major surface 19 of the elastomeric layer 14. In various embodiments, the second tie layer 22, which may be the same or different from the first tie layer 20, may be a silicone thermoplastic elastomer. Suitable silicone thermoplastic elastomers such as, for example, polydiorganosiloxane polyoxamide, silicone polyoxamide, and silicone polyureas described above for the first tie layer 20 may also be used in the second tie layer 22.

A first major surface 23 of a release liner 24 is on a second major surface 29 of the second tie layer 22. In the embodiment of FIG. 1, the release liner 24 includes a textured second major surface 25 with an arrangement of structures 26, although in various embodiments either or both of the major surfaces 23, 25 may be roughened, textured or include surface structures. In some embodiments, which are not intended to be limiting, the release liner 24 is a polymeric film made of a material chosen from polyurethanes; polyalkylenes, e.g. polyethylene and polypropylene; polybutadiene, polyisoprene; polyalkylene oxides, e.g. polyethylene oxide; polyesters, e.g PET and PBT; polyamides; polyimides, polysilicones, polycarbonates, polystyrenes, polytetrafluoroethylene, polyethylenephthalate, block copolymers of any of the proceeding polymers, and blends and combinations thereof. In some embodiments, the release liner 24 may be made of non-polymeric material such as, for example, densified Kraft paper or poly-coated paper such as polyethylene coated Kraft paper. Nonwoven or woven liners may also be used for the release liner 24. In various embodiments the liner 24 may be flexible or rigid. In some embodiments, which are not intended to be limiting, the liner 24 is about 0.5 mil (0.01 mm) thick to about 20 mils (0.50 mm) thick.

In some embodiments, all or a portion of the surface 23 of the release liner 24 may include a release coating (not shown in FIG. 1), which allows the release liner 24 to be easily peeled away from the second tie layer 22. In various embodiments, which are not intended to be limiting, the release coating on the surface 23 of the release liner 24 may be a fluorine-containing material, a silicone-containing material, a fluoropolymer, a silicone polymer, or a poly(meth)acrylate ester derived from a monomer comprising an alkyl (meth)acrylate having an alkyl group with 12 to 30 carbon atoms.

The structures 26 on the second major surface 25 of the release liner 24 are not particularly limited, and may include an embossed surface texture, or an array of precisely shaped structures with one or more shapes such as circular cylindrical; elliptical cylindrical; polygonal prisms, e.g. pentagonal prism, hexagonal prisms and octagonal prisms; pyramidal and truncated pyramidal, wherein the pyramidal shape may include between 3 to 10 sidewalls; cuboidal; e.g., square cube or rectangular cuboid; conical; truncated conical, annular, spiral and the like. The plurality of precisely shaped structures may be arranged randomly across the surface 25 of the release liner 24, or may be arranged in a repeating pattern. In various embodiments, which are not intended to be limiting, the repeating patterns include square arrays, hexagonal arrays, and combinations thereof.

In some embodiments, the plurality of precisely shaped structures 26 on the surface 25 of the release liner 24 are in continuous or discontinuous lines, which may be straight, curved or wavy and may be parallel, randomly spaced or placed in a pattern. Combinations of different line types and patterns may be used. The cross-sectional shape (the cross-section defined by a plane perpendicular to the length) of the lines is not particularly limited and may include, but is not limited to, triangular, truncated triangular, square, rectangular, trapezoidal, hemispherical and the like. Combinations of different cross-sectional shapes may be used.

In the example of the liner 24 shown in FIG. 1, which is not intended to be limiting, the pattern of structures 26 is an array of linear grooves having a pyramidal cross-sectional shape with an apex angle of about 90°. The pyramids have a height of about 70 microns and a base width of about 140 microns.

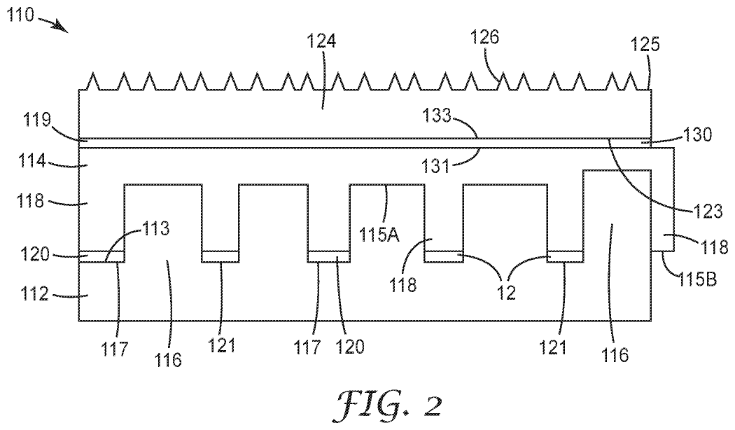

In another embodiment shown in FIG. 2, a laminate construction 110 includes a microstructured film tool 112 (hereafter referred to as the film tool 112) and a microstructured elastomeric film 114 (hereafter referred to as the elastomeric film 114) carried on the film tool 112. The film tool 112 includes an array of a plurality of precisely shaped structures 116, and may be used as a production template to form an array of a plurality of precisely shaped structures 118 in a first major surface 115A of the elastomeric film 114, with the array of structures 118 being the inverse of the array of structures 116.

A first tie layer 120 resides in the land areas 117 of the film tool 112 and contacts the surface 115B on the tops of the structures 118 on the first major surface 115A. A first major surface 131 of a polymeric film support layer 130 is on a second major surface 119 of the elastomeric film 114. A second major surface 133 of the polymeric film support layer 130 contacts a first major surface 123 of the release liner 124. A second major surface of the release liner 124 includes optional surface structures 126.

In some embodiments, the polymeric film support layer 130 may include one or more layers of polymeric films, which may be the same or different. The polymeric films may be chosen from, for example, polyurethanes; polyalkylenes, e.g. polyethylene and polypropylene; polybutadiene, polyisoprene; polyalkylene oxides, e.g. polyethylene oxide; polyesters, e.g PET and PBT; polyamides; polyimides, polysilicones, polycarbonates, polystyrenes, polytetrafluoroethylene, polyethylenephthalate, block copolymers of any of the proceeding polymers, and blends and combinations thereof. In various embodiments, the polymeric film support layer 130 may be flexible or rigid. In some embodiments, which are not intended to be limiting, the film support 130 has a thickness of about 0.5 mil (0.01 mm) to about 20 mils (0.50 mm).

In some embodiments, the polymeric film support layer 130 may be a composite construction including layers of polymeric films separated by release layers or tie layers to provide the construction 110 with a desired set of properties. In various embodiments, the release layers and tie layers in the polymeric film support layer 130 provide a controlled release from the second major surface 119 of the elastomeric film 114, the first major surface 123 of the release liner 124, or adhere the elastomeric film 114 to a target substrate.

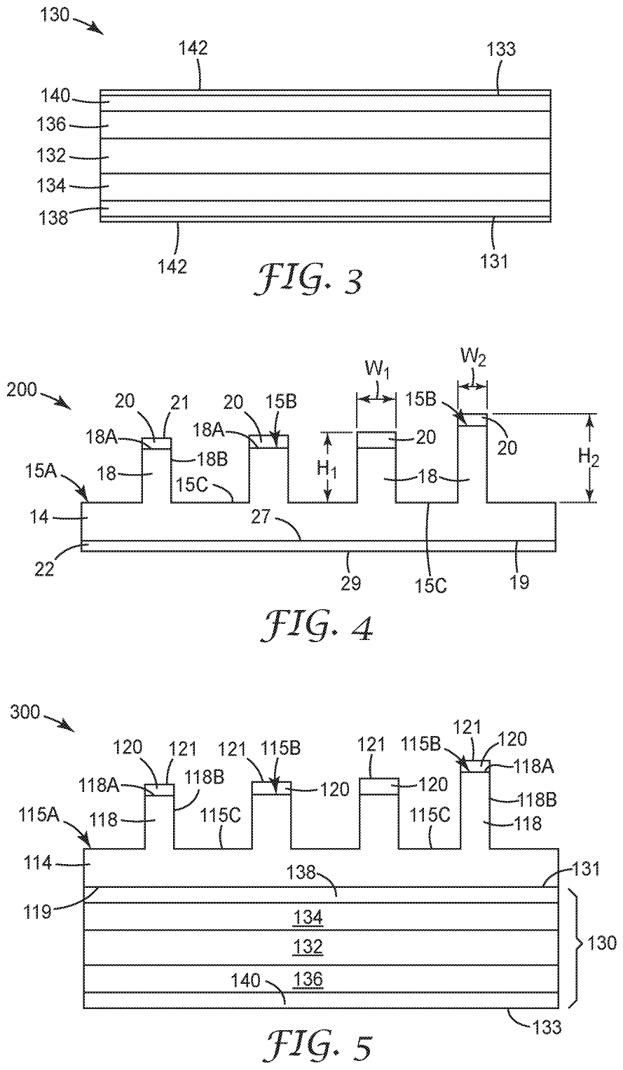

In one example shown in FIG. 3, which is not intended to be limiting, the polymeric film support layer 130 may include a relatively thick central polymeric film support 132 having on each major surface thereof first and second release layers 134, 136. A first relatively thin polymeric film layer 138 may be on the first release layer 134, and a second relatively thin polymeric film layer 140 may be on the second release layer 136.

In some embodiments, which are not intended to be limiting, the polymeric film layers 132, 138, 140 can be chosen from one or more of polyurethanes; polyalkylenes, e.g. polyethylene and polypropylene; polybutadiene, polyisoprene; polyalkylene oxides, e.g. polyethylene oxide; polyesters, e.g PET and PBT; polyamides; polyimides, polysilicones, polycarbonates, polystyrenes, polytetrafluoroethylene, polyethylenephthalate, block copolymers of any of the proceeding polymers, and blends and combinations thereof. In various embodiments, the release layers 134, 136 may also be polymeric films chosen from one or more of polyurethanes; polyalkylenes, e.g. polyethylene and polypropylene; polybutadiene, polyisoprene; polyalkylene oxides, e.g. polyethylene oxide; polyesters, e.g PET and PBT; polyamides; polyimides, polysilicones, polycarbonates, polystyrenes, polytetrafluoroethylene, polyethylenephthalate, block copolymers of any of the proceeding polymers, and blends and combinations thereof.

In some example embodiments, which are not intended to be limiting, the central support 132 has a thickness of about 10 microns to about 25 microns. In various embodiments, the release layers 134, 136 have a thickness of about 5 microns to about 15 microns, and the film layers 138, 140 have a thickness of about 1 micron to about 5 microns.

Further, in some embodiments, all or a portion of the outwardly-facing surfaces the polymeric support layer 130 (in the example of FIG. 3, the outwardly-facing surfaces of the layers 138, 140) may have applied thereon an optional adhesive primer layer 142. In various embodiments, which are not intended to be limiting, the adhesive primer layer 142 may be a silicone material such as X-33 from Shin-Etsu Chemical Co. of Tokyo, JP. In some embodiments, the adhesive primer layer 142 is applied in a pattern on the surfaces of the polymeric support layer 130 such as stripes, dots, swirls and the like.

Referring again to FIG. 1, as well as FIG. 4, the film tool 12 may be removed from the elastomeric film 14 such that the surfaces 21 of the first tie layers 20 separate from the surface 13 of the film tool 12. The surfaces 21 of the first tie layers 20 are then available for bonding in a subsequent processing step to a substrate such as, for example, an electrode of an electronic device. Further, the release liner 24 may be peeled away or otherwise removed from the second tie layer 22 at the same or a different time to expose the adhesive surface 29 for subsequent bonding steps and form an elastomeric construction 200.

In various embodiments, the elastomeric construction 200 includes adhesive tie layers 20 on all or a portion of the surface 15B of the elastomeric film 14. For example, in some embodiments the adhesive tie layers 20 are applied on only the surfaces 18A at the distal end of the structures 18 on the elastomeric layer 14. In other embodiments (not shown in FIG. 4), the adhesive tie layers 20 may be applied on the surfaces 18A and further extend onto the sidewalls 18B of the structures 18, or even into the land areas 15C between the structures 18.

Referring again to FIGS. 2-3, as well as FIG. 5, the film tool 112 may be removed from the elastomeric film 114 such that the surfaces 121 of the first tie layers 120 separate from the surface 113 of the film tool 112. The surfaces 121 of the first tie layers 120 are then available for bonding in a subsequent processing step to a substrate such as, for example, an electrode of an electronic device. Further, the release liner 124 may be peeled away or otherwise removed from the first major surface 131 of the support layer 130 at the same or a different time and form an elastomeric construction 300. In various embodiments, the elastomeric construction 300 includes adhesive tie layers 120 on all or a portion of the surface 115B of the elastomeric film 114. For example, in some embodiments the adhesive tie layers 120 are applied on only the surfaces 118A at the distal end of the structures 118 on the elastomeric layer 114. In other embodiments (not shown in FIG. 5), the adhesive tie layers 120 may be applied on the surfaces 118A and further extend onto the sidewalls 118B of the structures 118, or even into the land areas 115C between the structures 118.

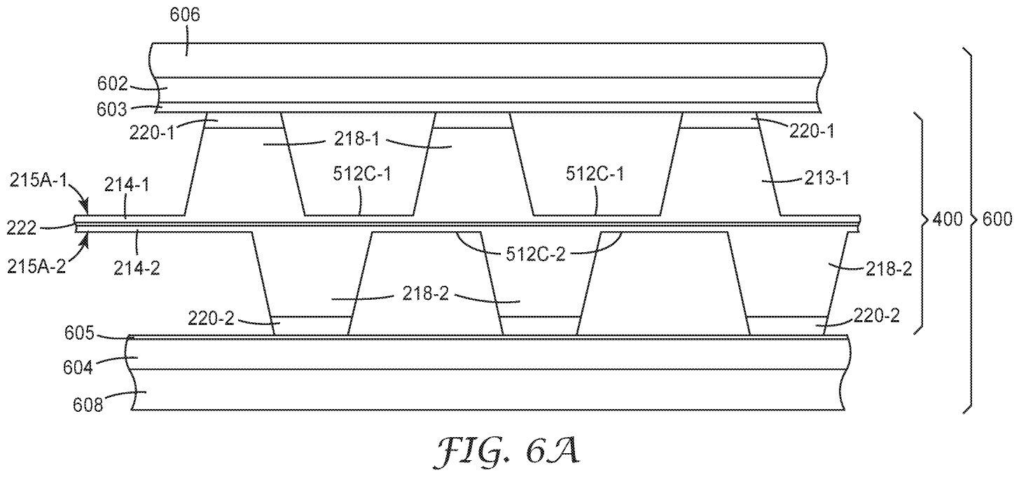

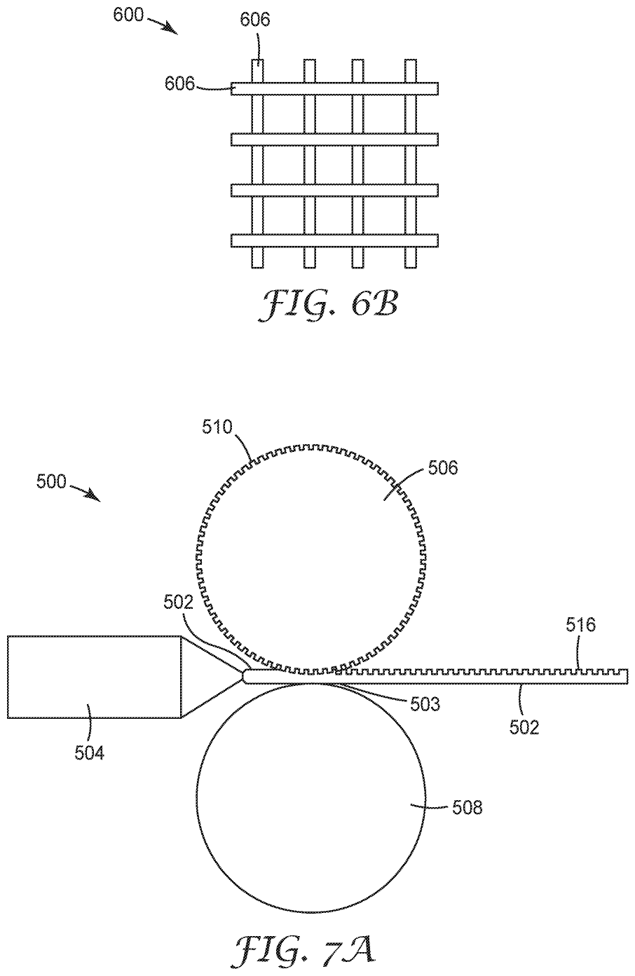

Referring to FIGS. 6A-6B, two elastomeric film constructions 200 of FIG. 5 can be adhered to one another in an overlapping grid-like pattern to form an array of compressible structures 400 for use in, for example, a touch-screen display device. The array of compressible structures 400 includes a first elastomeric film 214-1 attached to a second elastomeric film 214-2 via their respective tie layers 222. The elastomeric films 214-1 and 214-2 include lines of trapezoidal structures 218-1 and 218-2, respectively, which are separated by land areas 215C-1 and 215C-2. The distal end (top) of each trapezoidal structure includes an adhesive tie layer 220-1, 220-2.

The adhesive tie layers 220-1 and 220-2 are adhered to respective polymeric film layers 602, 604, all or a portion of which may optionally include an adhesive primer 603, 605. The polymeric film layers 602, 604 are in turn attached to respective conductive ink electrodes (for example, Ag, Cu, Au, and the like) 606, 608, to form a conductive electrode assembly 600 for use in an electronic device such as, for example, a touch screen display.

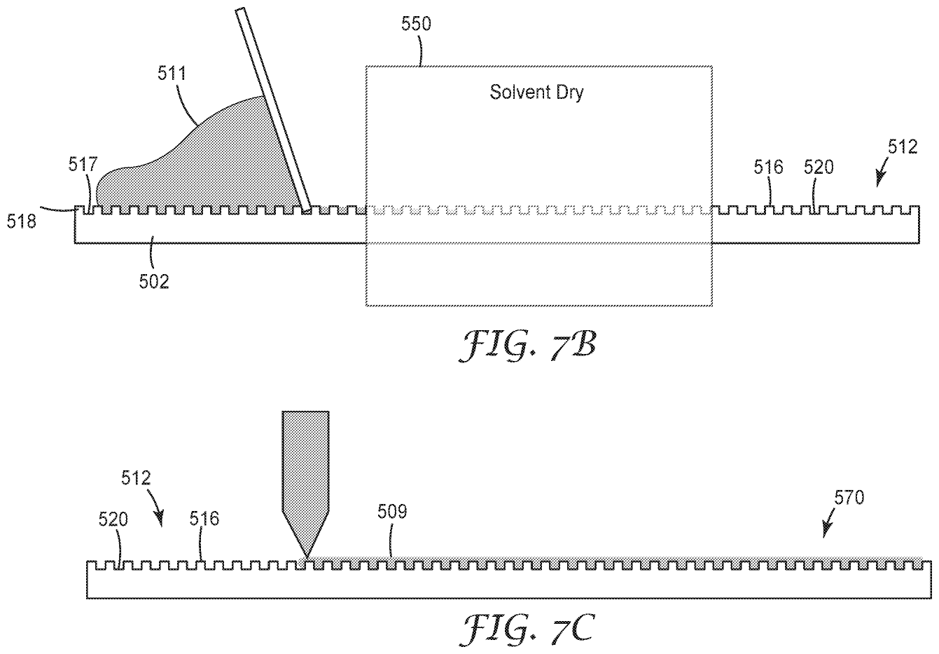

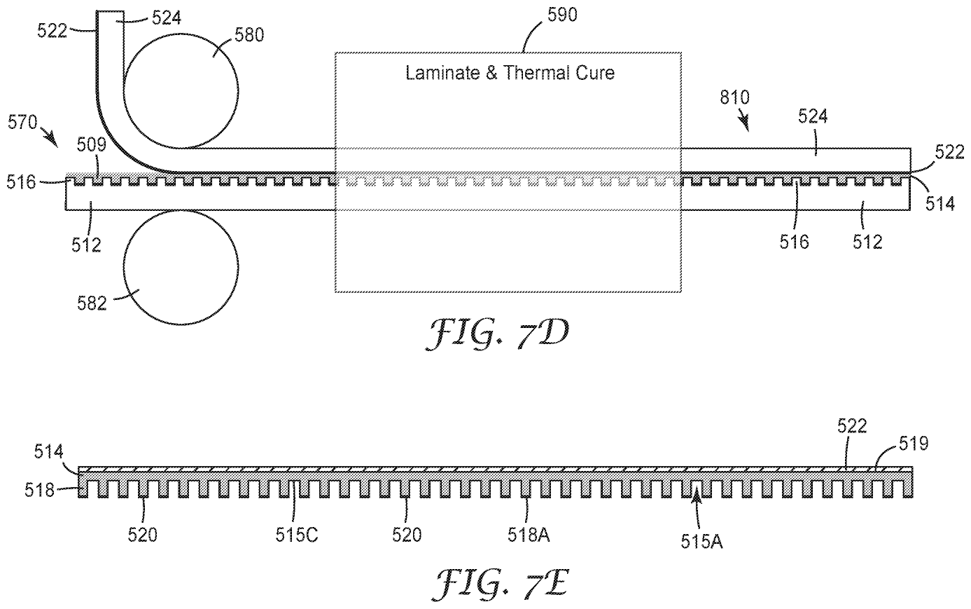

The microstructured film tool 12 described above in FIGS. 1-2 may be made using a wide variety of processes in which a polymeric material is cast or molded (or polymer precursor that is later cured to form a polymer) in a mold, or embossed by an embossing tool, which have a plurality of micron sized to millimeter sized topographical structures. When the polymer is removed from the production tool, a series of topographical structures are present in the surface of the polymer that have the inverse shape of the features of the original production tool. In one embodiment shown schematically in FIG. 7A, the film tool 12 may be efficiently manufactured using an extrusion replication process 500 in which a moldable polymeric material 502 is extruded from an extruder 504 into a gap 503 between a microstructured roller 506 and a backup roller 508. The mictrostructured roller 506 has on an exterior surface an arrangement of micron to millimeter sized topographical structures 510, which create a patterned arrangement of micron to millimeter sized structures 516 in the moldable polymeric material 502. In some embodiments, the structured moldable polymeric material 502 may optionally be dried or otherwise cured to form a film tool 512.

In some embodiments as shown in FIG. 7B, the land areas 517 between the structures 516 on the microstructured surface of the polymeric material 502 may be coated with a liquid tie layer material 511. The resulting construction may be dried or otherwise cured in an oven 550 to produce a film tool 512 with tie layer 520 in the land areas 517 between the structures 516 thereon.

As shown in FIG. 7C, an elastomeric material 509 may be cast on the film tool 512 to form an elastomeric construction 570.

Referring to FIG. 7D, a release liner 524 with an adhesive layer 522 thereon may be applied on the elastomeric construction 570 while passing through a nip between an arrangement of rollers 580, 582. In some embodiments, the release liner 524 may itself include surface structures (not shown in FIG. 7D). After lamination and curing in an oven 590, an elastomeric construction 810 may be obtained including a structured elastomeric layer 514 between the film tool 512 and the release liner 524.

As shown in FIG. 7E, the film tool 512 and the release liner 524 may be removed from the elastomeric layer 514 to expose an array or pattern of structures 518 on the structured surface 515A thereof. The distal ends 518A of the structures 518 have thereon the first tie layer 520, while the major surface 519 of the elastomeric layer 514 has thereon the second tie layer 522.

The elastomeric constructions of the present disclosure will now be further described in the following examples, which are not intended to be limiting.

### EXAMPLES

### Example 1

A micro-structured film tool was prepared by extrusion replication. The film tool was made of a polypropylene homo-polymer resin available under the trade designation PP1024 from ExxonMobil. One surface of the film tool has longitudinal linear channels with a trapezoidal cross-sectional shape, and the opposite backside surface was unstructured. The total thickness of the cast replicated film was approximately 0.20 mm. The channels in the structured surface of the film tool had a depth of about 0.17 mm, a width of about 0.2 mm, and a pitch of about 1.6 mm. The trapezoidal channels had a sidewall angle of about 6.5°, ±0.5°, and were separated by land areas of about 10 microns.

A polyolefin release liner was also prepared by an extrusion replication method. The liner was made of a copolymer polypropylene resin available under the trade designation Braskem C700-35N from Braskem USA, Philadelphia, Pa. One side of the liner surface had a smooth finish, and the opposite surface had rough finish with linear channels having a triangular cross section with a depth of about 70 microns and a pitch of about 140 microns. The sidewall angle between adjacent structures was about 90°.

A 25k silicone polyoxamide tie-layer coating solution was prepared by dissolving silicone polyoxamide pellets (25K silicone polyoxamide, available from 3M Company, St. Paul, Minn.) at 10% w/w in ethyl acetate. Silicone polyoxamides are described in U.S. Pat. No. 7,501,184 and are available upon request from 3M Company. The 25k silicone polyoxamide was described in this document per chemical formula I:

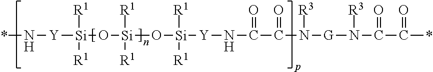

where R¹ is —CH₃, R³ is —H, G is —CH₂CH₂—, n is −335, p=1, Y is —CH₂CH₂CH₂—

The silicone polyoxamide tie-layer coating solution was notch bar coated onto the micro-structured surface side of the film tool to form a first tie layer. The notch bar was drawn along the film tool surface at constant pressure allowing the coating solution to flow into the film tool structure. The solution was allowed to dry in an oven for 1-2 minutes at 60° C.

The smooth side of the release liner was notch bar coated with a silicone polyoxamide coating solution to form a second tie layer. The notch bar was drawn along the liner at a constant gap, which was set at 0.005 inch (0.13 mm). The solution was allowed to dry in an oven for 1-2 minutes at 60° C.

Silicone precursor mixture 1 was prepared by mixing equal parts of ShinEtsu SES22350-30 Part A and ShinEtsu SES22350-30 Part B (available from Shin-Etsu Silicones of America) in a dynamic in-line mixer to form a Silicone Precursor Solution 1.

The Silicone Precursor Solution 1 was fed to a slot die and coated onto the structured side of a micro-structured film tool and over the first tie layer. The structured side of the film tool was then laminated to the second tie layer on the release liner in a nip to form a liner/tie-layer/silicone elastomeric layer/tie-layer/micro-structured film tool laminate illustrated schematically in FIG. 1. The laminate was treated in an oven at 240° F. (116° C.) for 13 minutes to cure the silicone precursor solution to handling and form a structured elastomeric layer with a Shore D hardness of about 30.

The channel dimensions of the structured elastomeric layer were estimated 200 um wide at lower base, 164 um wide at top base, 196 um high (including the landing thickness of 35 um), and channel pitch of 1.6 mm.

### Example 1A—Peel Strength Test

Peel adhesion force is defined in this application as the average load per unit width of bondline required to separate progressively a flexible member from a rigid member or another flexible member, measured at a specific angle and rate. The methods of sample preparation and testing are modifications of ASTM method D 1876-08, Standard Test Method for Peel Resistance of Adhesives. The samples were cut into 10 mm wide strips. Peel adhesion was measured as a 180° peel back at a crosshead speed of 300 mm/min using MTS Instron (MTS Systems Corp, Eden Prairie, Minn.). The peel adhesion force was reported as an average of three to ten replicates, in Newtons/mm.

A primer solution was prepared by blending 207 grams of dipentaerythritol pentaacrylate available under the trade designation SR 399 from Sartomer Company, Exon, Pa., with 2000 grams, 31.3% solids by weight, of surface treated silica particles in a 1-methoxy-2-propanol solution. The silica particles were surface-modified modified with 3-methacryloxypropyltrimethoxysilane functionality, such as those available under the trade designation Aerosil R-972 from Degussa Corporation, Parsippany, N.J. 8.3 grams of a free radical wetting agent, available under the trade designation TegoRad 2250 from Evonik Industries, Essen, Germany, was added. The entire solution was diluted to 10% solids using 2-butanone, available from Sigma Aldrich, St. Louis, Mo. The solution was vigorously mixed with an air to homogenize the solution.

The acrylic primer solution was coated at 5 mils (0.13 mm) wet thickness onto a 2 mil (0.05 mm) primed PET substrate and dried at 82° C. for 90 seconds. The film was exposed to ultraviolet radiation at a speed of 33 fpm, using two H bulb lamps available from Heraeus Noblelight America to create the primed substrate film referred to herein as Primed Substrate Film 1.

The release liner was removed from the elastomeric construction of Example 1, exposing the second tie-layer. The exposed surface of the second tie-layer was laminated to the primed side of Primed Substrate Film 1 with a hand roller, followed by nip roller at 40 psi.

The film tool was then removed from the resulting laminate, exposing the first tie-layer. The first tie-layer surface was laminated to the primed side of a second primed substrate film with a hand roller. The resulting Test Laminate 1A was heated to 85° C. for 10 minutes, producing a compressible, multilayer article, Example 1A.

The peel strength of Example 1A was measured as 0.05-0.06 N/mm.

### Example 1B

A 0.0013 inch (33 micron) PET film was coated with Adhesion promotor 111 (available from 3M Company), and the coating was dried for at least 1 minute at of 85° C. to form Primed Substrate Film 2.

Example 1B was prepared similarly to Example 1A, but using Primed Substrate Film 2 to form a Test Laminate 1B. Both outer surfaces of Test Laminate 1B were painted with electrically conductive silver ink, producing a compressible, multilayer article interfaced with electrodes.

The Peel strength of Example 1B was measured 0.01-0.02 N/mm.

### Example 2

A silicone polyoxamide tie-layer coating solution was notch bar coated onto the micro-structured surface side of the film tool to form a first tie layer as set forth in Example 1. The smooth side of a release liner was notch bar coated with a silicone polyoxamide coating solution to form a second tie as set forth in Example 1.

A Silicone Precursor Mixture 2 was prepared by mixing equal parts ShinEtsu SES22350-10 Part A and ShinEtsu SES22350-10 Part B (available from Shin-Etsu Silicones of America) in a dynamic in-line mixer to form a Silicone Precursor Solution 2.

Silicone Precursor Solution 2 was fed to a slot die and coated onto the first tie-layer side of the micro-structured film tool. The tie-layer side of liner/tie-layer laminate was laminated to the coated silicone precursor solution in a nip to form a liner/tie-layer/silicone elastomeric layer/tie-layer/micro-structured film tool laminate 2. The laminate 2 was treated in an oven at 240° F. (116° C.) for 13 minutes to cure the Silicone Precursor Solution 2 to handling and produce an elastomeric layer with a thickness of about 35 microns as measured using an optical microscope. The elastomeric layer had a Shore D hardness of about 10.

The channel dimensions of the structured elastomeric layer were approximately the same as in Example 1.

### Example 2A—Capacitive Compliance Test

Capacitive compliance in the present application was estimated a slope of linear fit of the plot of capacitance as function of compression force. A compressible article was sandwiched between two movable parallel plate electrodes to form compressible capacitor. Capacitance were measured at various compression force level to compressible capacitor. Electrodes were made from copper with dimensions of 15 mm×15 mm. The force range was 0 to about 600 grams.

The liner of the laminate from the elastomeric construction of Example 2 was removed, exposing the second tie-layer. The exposed second tie-layer surface was laminated to the primed side of the Primed Substrate Film 1 of Example 1 with a hand roller, followed by nip roller at 40 psi.

The film tool was removed from the resulting laminate, exposing the first tie-layer. The second tie-layer surface was laminated to the primed side of a second primed substrate film 1 with a hand roller to form a Test Laminate 2A. The Test Laminate 2A was heated to 85° C. for 10 minutes, producing a compressible, multilayer article. Both outer surfaces of laminate were painted with electrically conductive silver ink, producing a compressible elastomeric article, Example 2A.

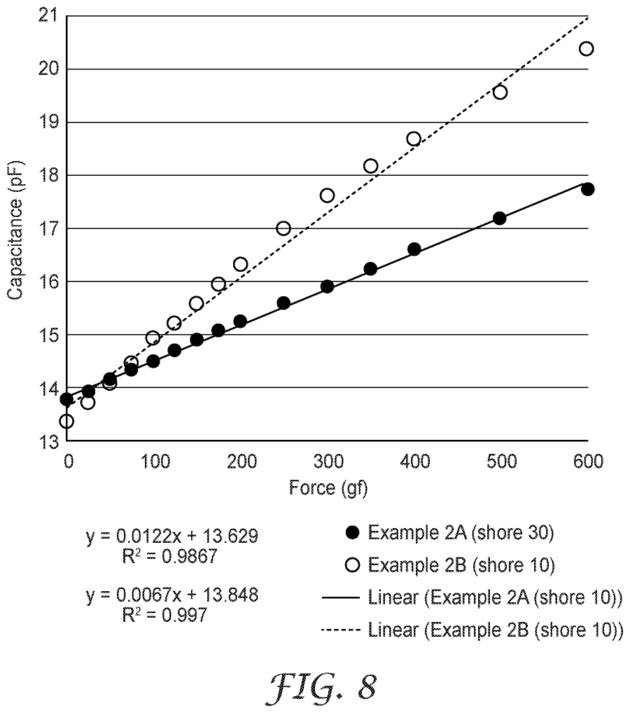

The capacitive compliance of the compressible elastomeric article of Example 2A was measured as 7 pF/gf, and is plotted in FIG. 8.

### Example 2B

The compressible elastomeric article of Example 2B was first prepared similarly to example 2A, but using Primed Substrate Film 2 described in Example 1 above.

The capacitive compliance of the compressible elastomeric article of Example 2B was measured 12 pF/gf, and is plotted in FIG. 8.

### Example 3

The silicone polyoxamide tie-layer coating solution of Example 1 was notch bar coated onto the micro-structured surface side of the film tool of Example 1 to form a first tie layer. The notch bar was drawn along the film tool surface at constant pressure allowing the coating solution to flow into the film tool structure. The solution was allowed to dry in an oven for 1-2 minutes at 60° C. The Silicone Precursor Mixture 1 of Example 1 above was fed to a slot die and coated onto the structured side of the micro-structured film tool and over the first tie layer.

A polymeric film support layer was prepared for lamination to the first tie layer side of the film tool. The polymeric film support layer was similar to the construction of FIG. 3 above, and included a core film layer of 0.50 mil (0.06 mm) PET available from 3M, St. Paul, Minn., under the trade designation 3M PhotoEC. On each major surface of the PET core film layer was a release layer of 90 parts polypropylene 8650 available from Total Petrochemicals USA, Houston, Tex., and 10 parts Kraton 1657G available from Kraton Performance Polymers, Belpre, Ohio. On each exposed surface of the release layers was a film of 0.20 mil (0.005 mm) PET. The polymeric film support layer had an overall thickness of about 1.70 mils (43 microns).

The polymeric film support layer was then laminated on the Silicone Precursor Solution 1 in a nip to form the micro-structured film tool laminate illustrated schematically in FIG. 2. The laminate was treated in an oven at 240° F. (116° C.) for 13 minutes to cure the silicone precursor solution to handling and form a structured elastomeric layer with a Shore D hardness of about 30.

The channel dimensions of the structured elastomeric layer were estimated 200 um wide at lower base, 164 um wide at top base, 196 um high (including the landing thickness of 35 um), and channel pitch of 1.6 mm.

### Example 4

A compressible elastomeric construction was prepared as in Example 3 above, except that the Silicone Precursor Mixture 2 of Example 2 above was used to form the elastomeric layer.

A first conductive Ag ink electrode was applied on the polymeric film support layer, and a first major surface of a primed PET film was applied on the second tie layer. A second conductive Ag ink electrode was applied on the second major surface of the primed PET film.

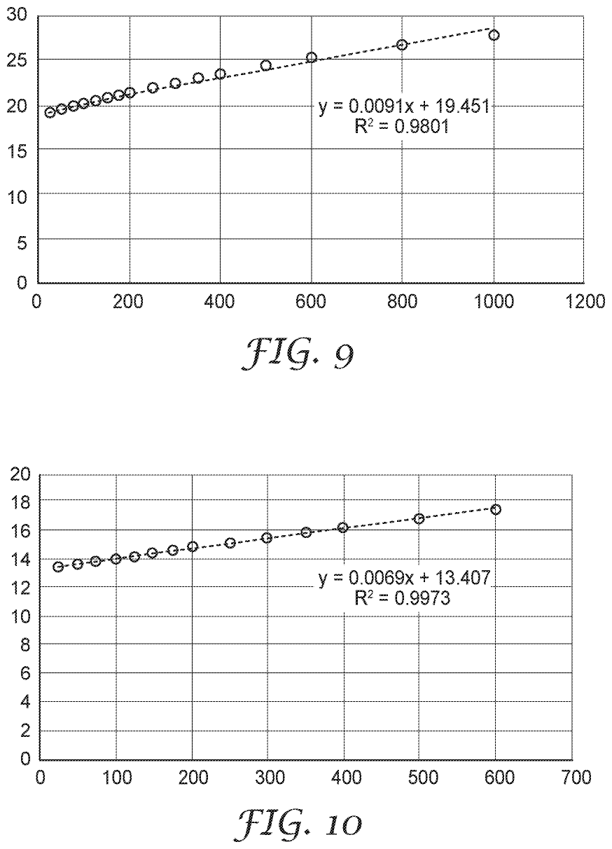

The capacitive compliance of the compressible elastomeric article of Example 4 is plotted in FIG. 9.

The peel strength of Example 4 was measured as 0.008-0.016 N/mm.

### Example 5

A compressible elastomeric construction was prepared as in Example 1 above, except that a Silicone Precursor Mixture 3 was used to form the elastomeric layer. Silicone Precursor Mixture 3 was prepared by mixing equal parts of ShinEtsu SES22350-10 Part A, ShinEtsu SES22350-30 Part A, ShinEtsu SES22350-10 Part BA, and ShinEtsu SES22350-30 Part B, (all available from Shin-Etsu Silicones of America) in a dynamic in-line mixer to form a Silicone Precursor Solution 3. The resulting elastomeric layer had a Shore D hardness of about 20.

Both outer surfaces were painted with electrically conductive silver ink, producing a compressible as described in Example 1B, producing a multilayer article interfaced with electrodes.

The capacitive compliance of the compressible elastomeric article of Example 5 is plotted in FIG. 10.

The peel strength of Example 5 was measured as 0.025-0.034 N/mm.

### Example 6

A compressible elastomeric construction was prepared as in Example 1 above, except that the Silicone Precursor Solution was prepared by dissolving silicone polyurea pellets (33K silicone polyurea, available from 3M, St. Paul, Minn.) at 10% w/w in ethyl acetate. Silicone polyureas are described in, for example, U.S. Pat. No. 5,214,119, and are available upon request from 3M. The resulting elastomeric layer had a Shore D hardness of about 20.

Both outer surfaces were painted with electrically conductive silver ink, producing a compressible as described in Example 1B, producing a multilayer article interfaced with electrodes.

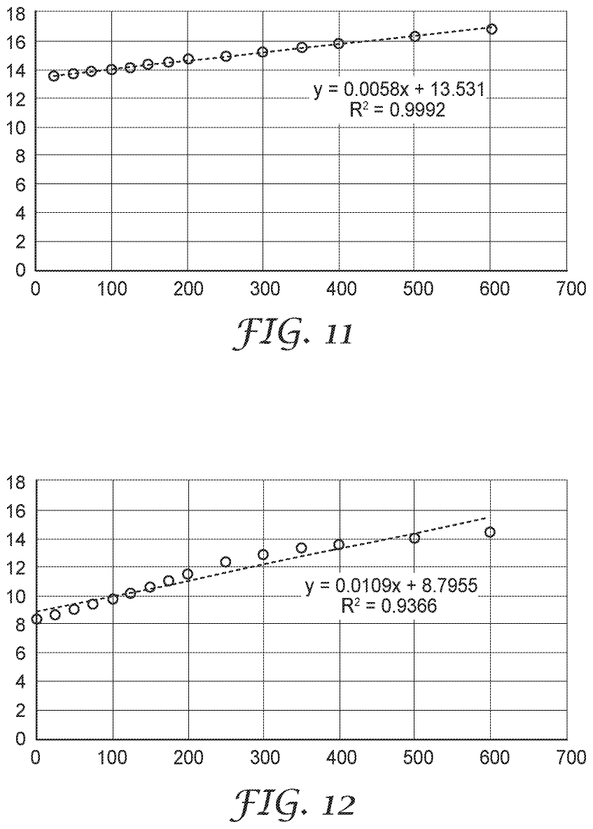

The capacitive compliance of the compressible elastomeric article of Example 6 is plotted in FIG. 11.

The peel strength of Example 6 was measured as 0.025-0.034 N/mm.

### Example 7

Two of the compressible elastomeric constructions of Example 1 above were laminated together to form an overlapping grid-like construction similar to that shown in FIGS. 6A-6B.

The capacitive compliance of the compressible elastomeric article of Example 7 is plotted in FIG. 12.

### Comparative Example 1

A structured elastomeric layer with the structured surface described in Example 1 above. On the surface of the elastomeric layer opposite the structures, a silicone tape available from 3M, St. Paul, Minn., under the trade designation Silicone Tape 8403 was applied. A first major surface of a tie layer of the silicone polyoxamide of Example 1 was applied on the tops of the trapezoidal structures in the elastomeric layer, and a primed PET film was applied on the second major surface of the tie layer.

The peel strength of the article of Comparative Example 1 was measured as 0.002-0.006 N/mm.

### EMBODIMENTS

### Embodiment A

A lamination transfer article, comprising:

an elastomeric layer with a first major surface comprising an array of discrete microstructures separated by land areas, wherein the microstructures in the array comprise a top surface;

a first tie layer overlying at least some of the top surfaces of the microstructures of the elastomeric layer, wherein the land areas on the first major surface are uncovered by the first tie layer;

and a second layer on a second major surface of the elastomeric layer, wherein the second layer is chosen from a second tie layer and a polymeric carrier film.

### Embodiment B

The article of Embodiment A, wherein the microstructures in the array further comprise sidewalls, and the first tie layer at least partially overlies at least some of the sidewalls of the microstructures.

### Embodiment C

The article of Embodiment A or B, wherein the second layer is a second tie layer comprising:

a first major surface on the second major surface of the elastomer layer, and a second major surface, wherein a release liner overlies the second major surface of the second tie layer.

### Embodiment D

The article of Embodiment C, wherein the release liner comprises a first major surface and as a second major surface, wherein the first major surface of the release liner is on the second major surface of the tie layer and the second major surface of the release liner comprises an array of microstructures.

### Embodiment E

The article of any of Embodiments A to D, wherein the second layer is a polymeric carrier film comprising a polymeric film and an adhesive primer layer, wherein the adhesive primer layer is on the second major surface of the elastomer layer.

### Embodiment F

The article of Embodiment E, wherein the polymeric carrier film comprises a laminate, the laminate comprising:

a core polymeric film with a first major surface and a second major surface;

a first release layer on the first major surface of the core polymeric film, and a second release layer on the second major surface of the core polymeric film; and

a first protective film layer on the first release layer, and a second protective film layer on the second release layer, wherein the first protective film layer contacts the adhesive primer layer.

### Embodiment G

The article of any of Embodiments A to F, wherein the array of microstructures comprises a repeating pattern.

### Embodiment H

The article of Embodiment G, wherein the repeating pattern comprises at least one of continuous or discontinuous lines.

### Embodiment I

The article of Embodiment H, wherein the repeating pattern comprises continuous lines, and the microstructures forming the lines have an acute trapezoidal cross-sectional shape.

### Embodiment J

The article of any of Embodiments A to I, wherein the elastomeric layer is chosen from a silicone thermoset material or a silicone thermoplastic material.

### Embodiment K

The article of any of Embodiments A to J, wherein the elastomeric layer is a silicone polyoxamide.

### Embodiment L

The article of any of Embodiments A to K, wherein at least one of the first tie layer and the second tie layer comprises a silicone polyoxamide.

### Embodiment M

A method for making an elastomeric article, comprising:

coating a first adhesive layer on a portion of a mictrostructured major surface of a tool, wherein the major surface of the tool comprises an array of discrete microstructures and cavities between the microstructures, wherein the first adhesive layer resides in the cavities and the tops of the microstructures protrude above the first adhesive layer, and wherein the adhesive layer has a first major surface contacting the microstructured major surface of the tool;

casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool;

laminating a release liner onto the second major surface of the layer of the elastomeric precursor material opposite the first major surface thereof, wherein the release liner comprises a second adhesive layer on the second major surface of the layer of the elastomeric precursor material and a polymeric film on the second adhesive layer; and curing the elastomeric precursor material to form an elastomeric layer.

### Embodiment N

The method of Embodiment M, comprising extruding a polymeric material into a nip between a microstructured roller and a backup roller to form the tool, prior to coating the first adhesive layer.

### Embodiment O

The method of Embodiment M or N, wherein the polymeric film of the release liner comprises a first major surface on the second adhesive layer and a second major surface opposite the first major surface, and wherein the second major surface of the polymeric film comprises an array of microstructures.

### Embodiment P

The method of any of Embodiments M to O, further comprising removing the polymeric release liner to expose the second adhesive layer.

### Embodiment Q

The method of Embodiment P, further comprising removing the tool to expose the first major surface of the elastomeric layer, wherein the first major surface of the elastomeric layer comprises an array of protruding microstructures corresponding to the array of cavities in the tool.

### Embodiment R

The method of any of Embodiments M to P, further comprising attaching at least one of the protruding microstructures or the second adhesive layer to a substrate.

### Embodiment S

The method of any of Embodiments M to P, wherein the substrate comprises an electrode.

### Embodiment T

A method for making an elastomeric article, comprising:

extruding a polymeric material into a nip between a microstructured roller and a backup roller to form a tool, wherein the tool comprises a first microstructured major surface and a second major surface opposite the first microstructured major surface, and wherein the microstructured major surface of the tool comprises an array of discrete microstructures and cavities between the microstructures;

coating a first adhesive layer on the mictrostructured major surface of the tool, wherein the first adhesive layer resides in the cavities and the tops of the microstructures protrude above the first adhesive layer, and wherein the adhesive layer has a first major surface contacting the microstructured major surface of the tool;

casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool;

laminating a carrier film onto the second major surface of the layer of the elastomeric precursor material opposite the first major surface thereof, wherein the carrier film comprises a second adhesive layer on the second major surface of the layer of the elastomeric precursor material and a polymeric laminate film on the second adhesive layer; and

curing the elastomeric precursor material to form an elastomeric layer.

### Embodiment U

The method of Embodiment T, wherein the polymeric laminate film comprises:

a core polymeric film with a first major surface and a second major surface;

a first release layer on the first major surface of the core polymeric film, and a second release layer on the second major surface of the core polymeric film; and

a first protective film layer on the first release layer, and a second protective film layer on the second release layer, wherein the first protective film layer contacts the second major surface of the layer of the elastomeric precursor material.

### Embodiment V

The method of any of Embodiments T to U, further comprising removing the carrier film to expose the second adhesive layer.

### Embodiment W

The method of any of Embodiments T to V, further comprising removing the tool to expose the first major surface of the elastomeric layer, wherein the first major surface of the elastomeric layer comprises an array of protruding microstructures corresponding to the array of cavities in the first microstructured surface of the tool.

### Embodiment X

The method of any of Embodiments T to W, further comprising attaching at least one of the protruding microstructures or the second adhesive layer to a substrate.

### Embodiment Y

The method of any of Embodiments T to X, wherein the substrate comprises an electrode.

### Embodiment Z

A compressive sensor, comprising:

a first elastomeric layer, comprising:
a first major surface comprising a first array of continuous lines of microstructures separated by land areas, wherein the lines of microstructures in the first array extend along a first direction in a first plane, wherein the microstructures in the first array project in a first direction normal to and above the first plane, and wherein the microstructures in the first array comprise a distal end with a top surface;
a first tie layer overlying at least some of the top surfaces of the microstructures of the first elastomeric layer, wherein the land areas on the first major surface are uncovered by the first tie layer; and
a second tie layer on a second major surface of the first elastomeric layer; and

a second elastomeric layer, comprising:
a first major surface comprising a second array of continuous lines of microstructures separated by land areas, wherein the lines of microstructures in the second array extend along a second direction in a second plane, and the second direction in the second plane is different from the first direction in the first plane, and wherein the microstructures in the array project in a second direction normal to and above the second plane, wherein the second direction normal to and above the second plane is opposite the first direction normal to and above the first plane, and wherein the microstructures in the first array comprise a distal end with a top surface;
a first tie layer overlying at least some of the top surfaces of the microstructures of the second elastomeric layer, wherein the land areas on the first major surface are uncovered by the first tie layer; and
a second tie layer on a second major surface of the second elastomeric layer, wherein the second tie layer on the second major surface of the second elastomeric layer contacts the second tie layer on the second major surface of the first elastomeric layer.

### Embodiment AA

The compressive sensor of Embodiment Z, wherein the second direction in the second plane is substantially normal to the first direction in the first plane such that the first array of continuous lines of microstructures in the first elastomeric layer is substantially normal to the second array of continuous lines of microstructures in the second elastomeric layer.

### Embodiment BB

The compressive sensor of any of Embodiments Z to AA, wherein the first array of continuous lines of microstructures in the first elastomeric layer contacts a first electrode and the second array of continuous lines of microstructures in the second elastomeric layer contacts a second electrode.

Various embodiments of the invention have been described. These and other embodiments are within the scope of the following claims.

1. A lamination transfer article, comprising:
an elastomeric layer with a first major surface comprising an array of discrete microstructures separated by land areas, wherein the microstructures in the array comprise a top surface;
a first tie layer overlying at least some of the top surfaces of the microstructures of the elastomeric layer, wherein the land areas on the first major surface are uncovered by the first tie layer; and
a second layer on a second major surface of the elastomeric layer, wherein the second layer is chosen from a second tie layer and a polymeric carrier film.

2. The article of claim 1, wherein the microstructures in the array further comprise sidewalls, and the first tie layer at least partially overlies at least some of the sidewalls of the microstructures.

3. A method for making an elastomeric article, comprising:
coating a first adhesive layer on a portion of a mictrostructured major surface of a tool, wherein the major surface of the tool comprises an array of discrete microstructures and cavities between the microstructures, wherein the first adhesive layer resides in the cavities and the tops of the microstructures protrude above the first adhesive layer, and wherein the adhesive layer has a first major surface contacting the microstructured major surface of the tool;
casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool;
laminating a release liner onto the second major surface of the layer of the elastomeric precursor material opposite the first major surface thereof, wherein the release liner comprises a second adhesive layer on the second major surface of the layer of the elastomeric precursor material and a polymeric film on the second adhesive layer; and
curing the elastomeric precursor material to form an elastomeric layer.

4. The method of claim 3, further comprising:
removing the polymeric release liner to expose the second adhesive layer;
removing the tool to expose the first major surface of the elastomeric layer, wherein the first major surface of the elastomeric layer comprises an array of protruding microstructures corresponding to the array of cavities in the tool; and
attaching at least one of the protruding microstructures or the second adhesive layer to a substrate.

5. The method of claim 4, wherein the substrate comprises an electrode.

6. A method for making an elastomeric article, comprising:
extruding a polymeric material into a nip between a microstructured roller and a backup roller to form a tool, wherein the tool comprises a first microstructured major surface and a second major surface opposite the first microstructured major surface, and wherein the microstructured major surface of the tool comprises an array of discrete microstructures and cavities between the microstructures;
coating a first adhesive layer on the mictrostructured major surface of the tool, wherein the first adhesive layer resides in the cavities and the tops of the microstructures protrude above the first adhesive layer, and wherein the adhesive layer has a first major surface contacting the microstructured major surface of the tool;
casting a layer of an elastomeric precursor material on second major surface of the adhesive layer opposite the first major surface thereof, wherein a first major surface of the layer of the elastomeric precursor material overlies the second major surface of the adhesive layer and covers the cavities between the microstructures and the tops of the microstructures in the tool;
laminating a carrier film onto the second major surface of the layer of the elastomeric precursor material opposite the first major surface thereof, wherein the carrier film comprises a second adhesive layer on the second major surface of the layer of the elastomeric precursor material and a polymeric laminate film on the second adhesive layer; and
curing the elastomeric precursor material to form an elastomeric layer.

7. The method of claim 6, wherein the polymeric laminate film comprises:
a core polymeric film with a first major surface and a second major surface;
a first release layer on the first major surface of the core polymeric film, and a second release layer on the second major surface of the core polymeric film; and
a first protective film layer on the first release layer, and a second protective film layer on the second release layer, wherein the first protective film layer contacts the second major surface of the layer of the elastomeric precursor material.

8. The method of claim 6, further comprising:
removing the carrier film to expose the second adhesive layer;
removing the tool to expose the first major surface of the elastomeric layer, wherein the first major surface of the elastomeric layer comprises an array of protruding microstructures corresponding to the array of cavities in the first microstructured surface of the tool; and
attaching at least one of the protruding microstructures or the second adhesive layer to a substrate.

9. A compressive sensor, comprising:
a first elastomeric layer, comprising:
a first major surface comprising a first array of continuous lines of microstructures separated by land areas, wherein the lines of microstructures in the first array extend along a first direction in a first plane, wherein the microstructures in the first array project in a first direction normal to and above the first plane, and wherein the microstructures in the first array comprise a distal end with a top surface;
a first tie layer overlying at least some of the top surfaces of the microstructures of the first elastomeric layer, wherein the land areas on the first major surface are uncovered by the first tie layer; and
a second tie layer on a second major surface of the first elastomeric layer; and
a second elastomeric layer, comprising:
a first major surface comprising a second array of continuous lines of microstructures separated by land areas, wherein the lines of microstructures in the second array extend along a second direction in a second plane, and the second direction in the second plane is different from the first direction in the first plane, and wherein the microstructures in the array project in a second direction normal to and above the second plane, wherein the second direction normal to and above the second plane is opposite the first direction normal to and above the first plane, and wherein the microstructures in the first array comprise a distal end with a top surface;
a first tie layer overlying at least some of the top surfaces of the microstructures of the second elastomeric layer, wherein the land areas on the first major surface are uncovered by the first tie layer; and
a second tie layer on a second major surface of the second elastomeric layer,
wherein the second tie layer on the second major surface of the second elastomeric layer contacts the second tie layer on the second major surface of the first elastomeric layer.

10. The compressive sensor of claim 9, wherein the second direction in the second plane is substantially normal to the first direction in the first plane such that the first array of continuous lines of microstructures in the first elastomeric layer is substantially normal to the second array of continuous lines of microstructures in the second elastomeric layer, and wherein the first array of continuous lines of microstructures in the first elastomeric layer contacts a first electrode and the second array of continuous lines of microstructures in the second elastomeric layer contacts a second electrode.
